(19) United States
(12) Patent Application Publication
(10) Pub. No.: US 2008/0042088 A1
(43) Pub. Date: Feb. 21, 2008

(54) Solenoid proportional control valve

(76) Inventor: Isao Suzuki, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 11/826,274

(22) Filed: Jul. 13, 2007

(30) Foreign Application Priority Data
Aug. 16, 2006 (JP) 222014/2006

(51) Int. Cl. F16K 31/02

(52) U.S. Cl. 251/129.08

(57) ABSTRACT

A solenoid proportional control valve that is capable of controlling a large flow rate and easy to manufacture is provided. The proportional solenoid valve comprises a main orifice 4 that is formed between an inlet portion 1 and an outlet portion 2 of the valve, such that a main valve head 5f, which is partially supported by the bellows 5a, is abutted against the main orifice 4, so as to be capable of adjusting a degree of opening of the main orifice 4a. An interior of the bellows communicates with the fluid outlet portion 2 of the valve. An accommodating chamber 6b is provided outside the bellows 5a, such that the accommodating chamber 6b and the inlet portion 1 of the valve are communicated by a first fixed orifice 6a. Further, the accommodating chamber 6b is provided with a secondary orifice 5e that communicates with the outlet portion 2 of the valve. A valve head 7a is disposed in the vicinity of the secondary orifice 5e, so as to be capable of adjusting the degree of opening of the secondary orifice 5e by means of the solenoid.

### CROSS REFERENCE TO RELATED APPLICATION

The present application claims priority under 35 U.S.C. section 119 to Japanese Patent Application No. 2006-222014, filed Aug. 16, 2006, which is herein incorporated by reference in its entirety for all purposes.

### BACKGROUND OF THE INVENTION

1. Technical Field

The present invention relates to a solenoid proportional control valve for controlling a flow rate of a fluid, in particular, a solenoid-driven proportional control valve adapted for a relatively large flow rate of a fluid to be controlled.

2. Related Art

Conventional proportional control valves including solenoids use a large coil and a large current to generate a large force required for a relatively large fluid flow rate. Therefore, such valves are large in size and high in power consumption. Further, U.S. Pat. No. 5,810,030 and U.S. Pat. No. 4,796,854 disclose proportional control valves of a so-called differential-pressure balancing type that use a bellows or a diaphragm to balance a differential pressure applied to a valve body, whereby a large flow rate is controlled with a small solenoid force. U.S. Pat. No. 5,810,030 and U.S. Pat. No. 4,796,854 are all hereby incorporated by reference in their entirety. U.S. Pat. Nos. 4,717,116 and 6,182,681B1 are also referenced.

The valves disclosed in U.S. Pat. No. 4,796,854 and U.S. Pat. No. 5,810,030 have a movable valve head supported by a bellows and obtain a required force from a primary pressure introduced to the bellows from inside or outside. Such a valve has a complex mechanism for transmitting a solenoid force to a valve body supported by the bellows; thus, as a disadvantage, the cost of manufacturing these valves is high.

### SUMMARY OF THE INVENTION

Therefore, an object of the present invention is to use a small solenoid valve to produce a solenoid proportional control valve that is capable of controlling a large flow rate and is easy to manufacture.

A solenoid proportional control valve of the present invention comprises: a main orifice formed between a fluid inlet portion and a fluid outlet portion of the valve; a main valve head supported by a part of a flexible bellows, the main valve head being adapted to adjust a conductance of the main orifice; a secondary orifice provided on a moving axis of flexible bellows through which a fluid passes from one side of the bellows to the other side of the bellows; an accommodating chamber for accommodating the flexible bellows; a first flow channel between the accommodating chamber and the fluid inlet portion; a second flow channel between secondary orifice and the fluid outlet portion through which a fluid passes from the accommodating chamber to the fluid outlet potion; and a solenoid provided with a valve head on the moving yoke coaxially with the secondary orifice to adjust a conductance of the secondary orifice; wherein, a degree of opening of the secondary orifice is controlled by the solenoid to adjust a pressure on an outer side of the flexible bellows, so as to be capable of adjusting the conductance of the main orifice.

According to one aspect of the present invention, a main valve head is supported by a disk spring that has openings communicating with the outlet portion and a circular edge that is fixed to one side of the flexible bellows.

### BRIEF DESCRIPTION OF THE DRAWINGS

Referring now to the attached drawings which form a part of this original disclosure:

FIG. 1 is a vertical cross-sectional view of a solenoid proportional control valve according to an embodiment of the present invention.

FIG. 2A is a plan view of a bellows valve body of the solenoid proportional control valve according to the embodiment of the present invention.

FIG. 2B is a vertical cross-sectional view of the bellows valve body of the solenoid proportional control valve according to the embodiment of the present invention.

FIG. 3 is a vertical cross-sectional view of a solenoid valve portion of the solenoid proportional control valve according to the embodiment of the present invention.

FIG. 4A is a plan view of a main valve head of the solenoid proportional control valve according to another embodiment of the present invention.

FIG. 4B is a vertical cross-sectional view of the main valve head of the solenoid proportional control valve according to another embodiment of the present invention.

### DETAILED DESCRIPTION OF THE PREFERRED EMBODIMENTS

Below, an embodiment of the solenoid proportional control valve of the present invention will be described with reference to accompanying figures. In the figures, like elements are denoted by like reference numerals, and redundant descriptions are omitted.

### Embodiment

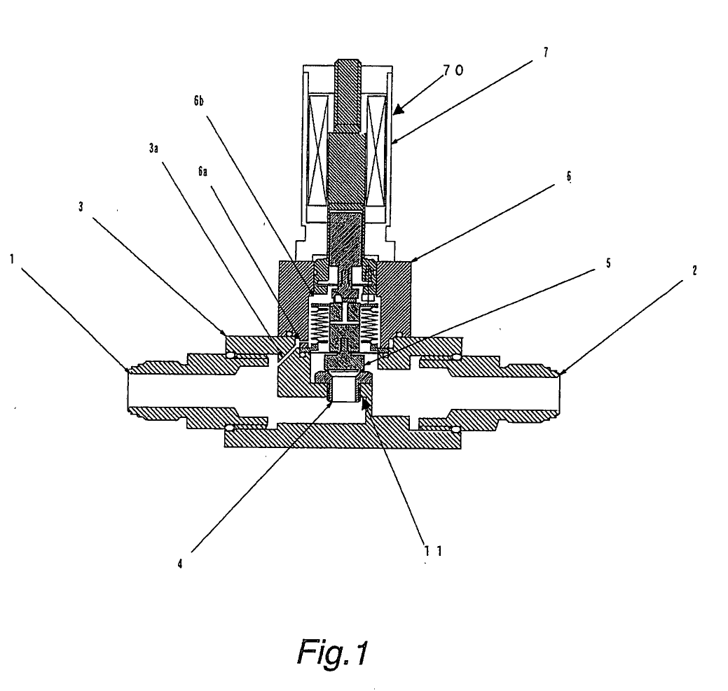

FIG. 1 is a schematic structural view of a solenoid proportional control valve according to an embodiment of the present invention. The solenoid proportional control valve is provided with a base 3 of a rectangular solid having a valve opening 11 in which a fluid flow channel and a main orifice 4 are disposed.

An inlet portion 1, which is connected to a fluid source, is screwed into an opening on one side of the base 3, and an outlet portion 2, which is connected to a fluid exhaust portion, is screwed into an opening on another side of the base 3. A hole, which serves as a valve chamber, is formed from a central portion of the base 3 upward, and a valve case 6 is fitted into the hole. The valve case 6 has a hole extending in a vertical direction in the figure and is secured by a bolt that extends from the valve case 6 to the base 3. The valve case 6 is provided thereabove with a solenoid case 70 for a solenoid 7. The valve case 6 and the solenoid case 70 are secured by, for example, bolts.

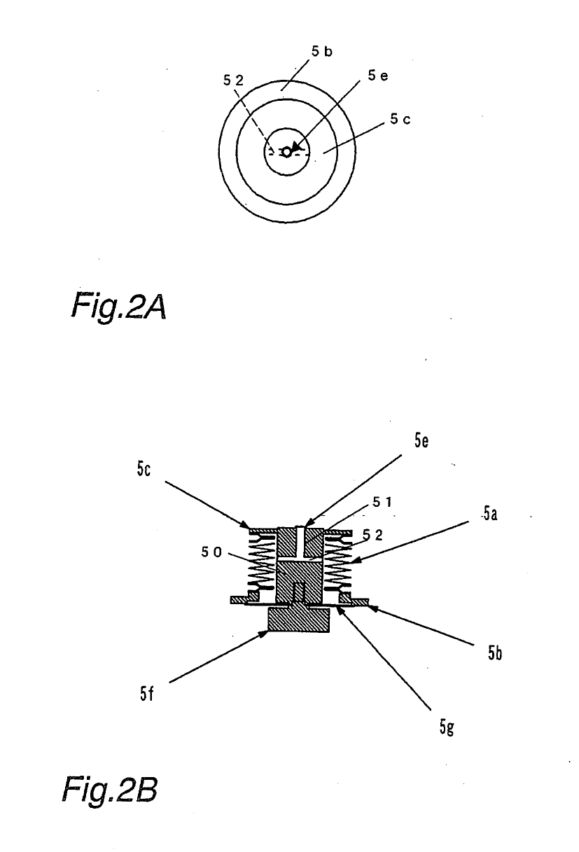

The valve case 6 is provided therein with an accommodating chamber 6b for accommodating a bellows valve body 5. The bellows 5a shown in FIG. 2B is made from welded thin metal disks and has an effective diameter larger than an inner diameter of the main orifice 4. The bellows valve body 5 accommodated in the chamber 6b is structured as shown in FIG. 2A and FIG. 2B. The main valve head 5f, that is disposed at a position corresponding to the main orifice 4, is fixedly screwed, via a disc spring 5g, into a bottom portion of a pillar 50 that is disposed upright at a central portion of the bellows 5a. As shown in Japanese Patent No. 3322772, the disc spring 5g has a plurality of arms extending in a radial direction to define openings between the arms, such that fluid is free to flow in and out. Japanese Patent No. 3322772 is hereby incorporated by reference in its entirety.

The pillar 50 has a flange 5c extending from a head of the pillar 50. The flange 5c is welded to an upper end of the bellows 5a. A lower end of the bellows 5a is welded to a ring-shaped flange 5b.

A secondary orifice 5e is formed at a central portion of the head of the pillar 50. A hole 51 is formed in a vertical direction from the secondary orifice 5e and is connected, approximately at a central portion of the pillar 50, to a lateral hole 52 that passes through the pillar 50 towards opposite lateral sides of the pillar 50. Therefore, the pillar 50 is provided with a flow channel that leads fluid from the secondary orifice 5e into the bellows 5a. Fluid, which is introduced through the secondary orifice into the bellows, is transmitted through the above-described disc spring 5g to the outlet portion 2 of the base 3.

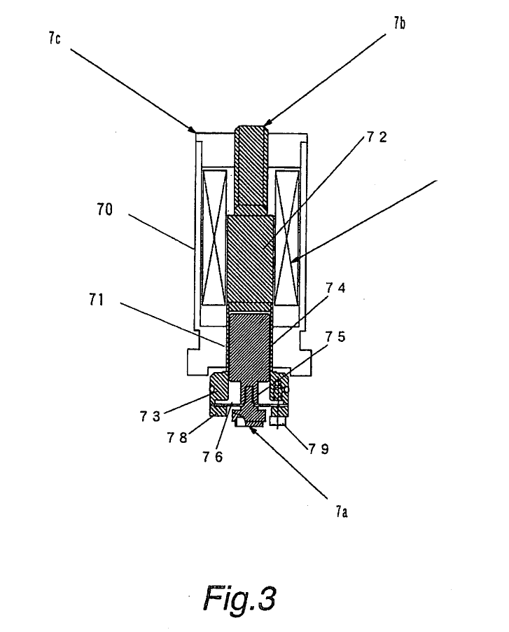

The solenoid valve portion, which is disposed above the bellows valve body 5, is structured as shown in FIG. 3, and basically adopts a structure as disclosed in Japanese Patent No. 3322772. That is, the solenoid valve is cylindrical in shape and accommodates a solenoid 7d of a cylindrical bobbin shape in the solenoid case 70 having a hole 71 formed in a lower central portion thereof, and a cover member 7c is screwed into the solenoid valve.

A central portion of the cover member 7c is threaded to engage with a rod-shaped span adjustment screw 7b that has a lower portion connected to a yoke 72. The yoke 72 is welded to a flange 73 having an upper hollow portion in which a cylindrical moving core 74 is disposed. The valve head 7a is fixedly screwed, via the disc spring 76, into an arm 75 formed at a lower portion of the moving core 74. The disc spring 76 is fixed to a tip of the flange 73 by screws 79, using the ring 78 as a holding member. The structure of the disc spring 76 is the same as that disclosed in Japanese Patent No. 3322772.

As shown in FIG. 1, a flow channel 3a to the chamber 6b is formed from a ceiling side of the base 3 connecting with the inlet portion 1. A portion of the flow channel 3a communicating with the accommodating chamber 6b forms a fixed orifice 6a at a bottom part of the chamber 6b.

The solenoid proportional control valve structured as described above is adapted to proportionally control the position of the valve head 7a that is driven by the solenoid 7 shown in FIG. 3. When an electric current is not applied to the solenoid 7d, the valve head 7a is in contact with the secondary orifice 5e to close it. Next, operation of the above-described solenoid proportional control valve will be described.

In the above-described state, a fluid passes through the flow channel 3a from the inlet portion 1 and flows through the fixed orifice 6a into the accommodating chamber 6b to apply a pressure to an outer side of the bellows 5a. The force generated by above pressure is larger than the force that pushes up the main valve head 5f by fluid pressure through the main orifice 4. Therefore, the main valve head 5f is pressed toward the main orifice 4 to act against a fluid inflow pressure, so as to block a fluid flow to the outlet portion 2.

Next, when an electric current is applied to the solenoid 7, the valve head 7a is pulled up toward the solenoid 7 according to the amount of the electric current to open the secondary orifice 5e. In this way, fluid in the accommodating chamber 6b flows through the secondary orifice 5e and the holes 51 and 52 of the pillar 50 into the bellows 5a. The fluid, which has flowed into the bellows 5a, is then transmitted through the openings formed between the arms of the disc spring 5g and is discharged into the outlet portion 2. In this way, the pressure in the accommodating chamber 6b is reduced to decrease the pressure applied to the bellows 5a to press the main valve head 5f toward the main orifice 4, thereby opening the main orifice 4 to allow the fluid to flow through the main orifice 4. The main orifice 4 can be designed to have any inner diameter according to the effective diameter of the bellows to be used. Therefore, a very large flow rate can be controlled.

In the above description, the diameter of the fixed orifice 6a is designed to be smaller to some degree than the diameter of the secondary orifice 5e, such that the pressure in the accommodating chamber 6b, when the valve head 7a is pulled up to an uppermost position, approaches the pressure in the outlet portion 2. In this way, when the valve head 7a is pulled up to a predetermined position, the pressure in the chamber 6b is reduced to cause the secondary orifice 5e to move upward, thereby opening the main valve head 5f to flow the fluid through the main orifice 4 into the outlet portion 2. At this time, the secondary orifice 5e approaches the valve head 7a and stops at a position where the pressure on the outer side of the bellows 5a balances the force of the fluid passing through the main orifice 4 and pushing up the main valve head 5f. Therefore, the degree of opening of the main orifice 4 becomes proportional to a given degree of opening of the secondary orifice 5e, to allow proper control of the flow rate. When the solenoid 7d is powered off and secondary orifice 5e is closed, the amount of fluid flowing into the accommodating chamber pressurizes the camber so as to softly move the main valve head 5f down. As a result, the lifetime of the main valve head 5f and the main orifice 4 can be extended.

In the present embodiment, the inner diameter of the fixed orifice 6a is set at 0.5 mm; the inner diameter of the secondary orifice 5e is set at 2 mm; and the inner diameter of the main orifice 4 is set at 12 mm. In other words, the degree of opening of the main orifice 4 with the inner diameter of 12 mm can be adjusted by a structure using the solenoid 7 for driving the secondary orifice 5e with the inner diameter of 2 mm. When air is used as a fluid, a flow rate of a few hundred liters/minute can be controlled.

In the structure of the present embodiment, the valve head 7a can be adjusted to any position by the position of the solenoid 7 to obtain a valve with good controllability. Further, since the solenoid proportional control valve of the present invention can be formed by incorporation of a separate proportional solenoid into the valve, manufacturing costs including assembly/adjustment costs and so on can be reduced.

In the present invention, when the secondary orifice is closed by the solenoid, the pressure in the accommodating chamber increases and acts to push down the bellows valve body, thereby closing the main orifice. When the secondary orifice is opened by the solenoid, the pressure in the accommodating chamber decreases and allows the bellows to expand, thereby opening the main orifice and thus the valve. Since the degree of valve opening of the main orifice is determined by the pressure in the accommodating chamber, the main orifice can be adjusted to any degree of opening by adjusting the degree of opening of the secondary orifice by means of the solenoid. The diameter of the secondary orifice can be made considerably smaller than that of the main orifice; therefore, an operation can be performed even by a small-sized, low-power solenoid. This makes it possible to adjust the degree of opening of a valve with a large orifice. As a result, the valve can be reduced in size and power consumption. Further, a solenoid having a moving valve head can be assembled separately and disposed for control of the bellows in the accommodating chamber, so as to facilitate a manufacturing process.

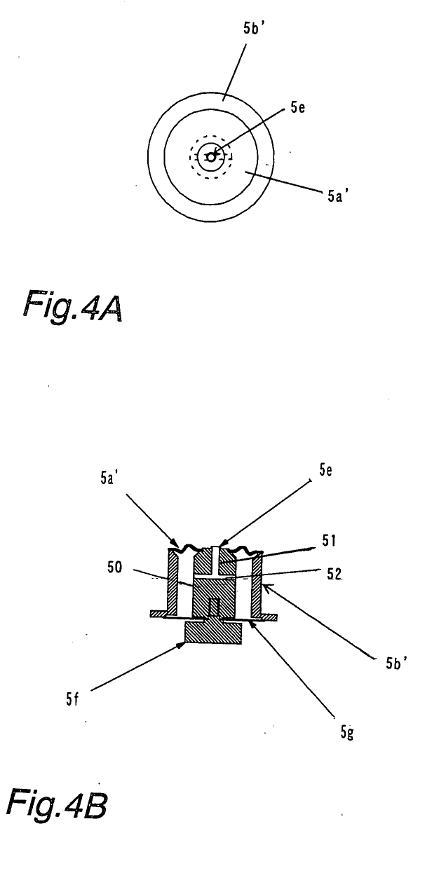

In the above embodiment metal bellows is used in the valve main body 5 as a flexible separator to isolate a fluid between the accommodating chamber 6b and the valve camber of base 3 except the potion of secondary orifice 5e. It is clear that the separator can be made for example, as shown in FIGS. 4A and 4B, a sheet diaphragm 5a′ made from metal and/or polymer resin which is supported by an outer ring 5b′ and a center disk where a secondary orifice 5e is structured. The center disk is partially thicker at the center portion than the other portion. The secondary orifice 5e is provided at the center portion. According to this modification, the form of an accommodating chamber 6b can be minimizing.

Since certain changes and modifications can be made in the above embodiments without departing from the scope of the invention as defined in the appended claims. Further, the foregoing descriptions of the embodiments according to the present invention are provided not for the purpose of limiting the invention as defined by the appended claims and their equivalents.

What is claimed is:

1. A proportional solenoid valve comprising:
a main orifice formed between a fluid inlet portion and a fluid outlet portion of the valve;
a main valve head supported by a part of a flexible bellows, the main valve head being adapted to adjust a conductance of the main orifice;
a secondary orifice provided on a moving axis of flexible bellows through which a fluid passes from one side of the bellows to the other side of the bellows;
an accommodating chamber for accommodating the flexible bellows;
a first flow channel between the accommodating chamber and the fluid inlet portion;
a second flow channel between the secondary orifice and the fluid outlet portion through which a fluid passes from the accommodating chamber to the fluid outlet potion; and
a solenoid provided with a valve head on the moving yoke coaxially with the secondary orifice to adjust a conductance of the secondary orifice, wherein,
a degree of opening of the secondary-orifice is controlled by the solenoid to adjust a pressure on an outer side of the flexible bellows, so as to be capable of adjusting the conductance of the main orifice.

2. A solenoid proportional control valve according to claim 1, wherein the diameter of the flexible bellows is specified to be larger than the diameter of the main orifice to get enough force to close the main orifice.

3. A solenoid proportional control valve according to claim 1, wherein the conductance of the first flow channel is smaller than the conductance of the second flow channel to reduce the force applied to the flexible bellows so as to allow the main orifice to open enough when the valve head of the solenoid is fully opened.

4. A solenoid proportional control valve according to claim 1, wherein the flexible bellows is made from metal, one end of which is welded to a metal disk where a secondary orifice is provided against the valve head, and further the main valve head is provided at the other side of the metal disk against the main orifice.

5. A proportional solenoid valve comprising:
a main orifice formed between a fluid inlet portion and a fluid outlet portion of the valve;
a main valve head supported by a part of a flexible diaphragm, the main valve head being adapted to adjust a conductance of the main orifice;
a secondary orifice provided on a part of flexible diaphragm through which a fluid passes from one side of the diaphragm to the other side of the diaphragm;
an accommodating chamber for accommodating the flexible diaphragm;
a first flow channel between the accommodating chamber and the fluid inlet portion;
a second flow channel between the secondary orifice and the fluid outlet portion through which a fluid passes from the accommodating chamber to the fluid outlet potion; and
a solenoid provided with a valve head on the moving yoke coaxially with the secondary orifice to adjust a conductance of the secondary orifice, wherein,
a degree of opening of the secondary orifice is controlled by the solenoid to adjust a pressure on an outer side of the flexible diaphragm, so as to be capable of adjusting the conductance of the main orifice.

6. A solenoid proportional control valve according to claim 5, wherein the diameter of the flexible diaphragm is specified to be larger than the diameter of the main orifice to get enough force to close the main orifice.

7. A solenoid proportional control valve according to claim 5, wherein the conductance of the first flow channel is smaller than the conductance of the second flow channel to reduce the force applied to the flexible diaphragm so as to allow the main orifice to open enough when the valve head of the solenoid is fully opened.

8. A solenoid proportional control valve according to claim 5, wherein the flexible diaphragm is made from a metal sheet having a center disk which is partially thicker at the center portion than the other portion, at the center portion the secondary orifice being provided against the valve head, and further the main valve head is provided at the other side of the center disk against the main orifice.
